(19) United States
(12) Patent Application Publication
(10) Pub. No.: US 2003/0034147 A1
(43) Pub. Date: Feb. 20, 2003

(54) Apparatus which eliminates the need for idling by trucks

(76) Inventors: Glenn M. Houck, Oklahoma City, OK (US); Danny K. Houck, Oklahoma City, OK (US)

Correspondence Address: Fisher Christen & Sabol, Suite 1401, 1725 K Street, N.W., Washington, DC, 20006, US

(21) Appl. No.: 10/156,236

(22) Filed: May 29, 2002

Related U.S. Application Data
(60) Provisional application No. 60/294,244, filed on May 31, 2001.

(51) Int. Cl. B60H 3/00

(52) U.S. Cl. 165/42

(57) ABSTRACT

An apparatus which eliminates idling for the over-the-road large trucks. It also gives conveniences, such as, access to 120 volts of ac power in a mobile application and also an alternate 12 volt dc supply which will maintain battery banks that in turn will operate 12 volt (dc) accessories.

This application has benefit of Provisional Application No. 60/294,244, filed on May 31, 2001.

### FIELD OF THE INVENTION

The invention relates to means for eliminating the need for trucks to idle their engines when the trucks are not traveling or otherwise in motion under engine power. The invention also relates to trucks containing such means for idle elimination.

### BROAD DESCRIPTION OF THE INVENTION

The invention involves means that eliminate the need for idling of the motor of over-the-road large trucks and other motorized land and water vehicles, such as, recreational vehicles, motor homes, camping trailers drawn by motorized vehicles, and motorized boats (including sail boats with engines), when such trucks, etc., are not traveling or otherwise in motion under motorized (engine) power. The invention also involves over-the-road large trucks, and other motorized land and water vehicles, that contains such means that eliminates the need for idling of the motor of road large trucks, etc., when the trucks, etc., are not traveling or otherwise in motion under motorized power.

The apparatus for elimination of the need for idling of the engine of the truck when the truck is not moving under motorized power, includes: (a) means for heating and cooling the cab of the truck; (b) means for charging at least one battery in the truck; and (c) generator means for supplying electricity to means (a) and means (b).

Preferably, generator means (c) is a generator. Preferably, the generator also supplies electricity to the electrical systems of the truck other than means (a) and means (b). Preferably, means (a) is a unit capable of heating and cooling the atmosphere in the cab of the truck. Preferably, means (b) is a battery charger. Preferably, generator means (c) is a generator and a battery, the battery being capable of starting the generator, with the battery charger being capable of charging the battery of generator means (c). Preferably, in the apparatus, generator means (c) is a generator, means (a) is a unit capable of heating and cooling atmosphere in the cab of the truck and means (b) is a battery charger. Preferably, means (a) is contained in a single enclosure that is mounted on the frame of the truck. Preferably, the enclosure is located under a door of the cab of the truck and has a step appendage. Preferably, the apparatus also includes an immersion block heater that is installed in a water jacket in the engine block of the engine of the truck.

The invention also involves the combination of a truck and the invention apparatus. The apparatus is mounted on the truck. The apparatus eliminates the need for idling of the engine when the truck is not moving under motorized power. The apparatus includes: (a) means for heating and cooling the cab of the truck; (b) means for charging at least one battery in the truck; and (c) generator means for supplying electricity to means (a) and means (b).

The invention also involves the combination of a motorized boat and the invention apparatus. The apparatus is mounted on the boat. The apparatus eliminates the need for idling of the engine of the boat when the boat is not moving under motorized power. The apparatus includes: (a) means for heating and cooling the interior of the boat; (b) means for charging at least one battery in the boat; and (c) generator means for supplying electricity to means (a) and means (b).

A truck is an automotive vehicle equipped with a swivel or the like for hauling a trailer. Sometimes herein the term truck is meant to mean a tractor or truck trailer, which is a truck with a short chassis and a cab used in combination with a trailer for the highway hauling of freight. The cab encloses the driver(s), the operating controls, usually sleeping quarters, and the like.

The apparatus for elimination of the need for idling of a truck when the truck is not traveling includes a generator power unit built inside of an enclosure to make it weatherproof. The complete engine/generator assembly mounted inside of the box enclosure is called the IDLE ELIMINATOR™ (trademark owned by Glenn M. Houck). The idle elimination apparatus was designed for the trucking industry. The purpose is to eliminate idling of the truck engine at night while the driver is sleeping or any other time the truck is not traveling. The idle elimination apparatus is mounted onto the main frame rail of a truck. It is bolted in place by the use of “L” brackets, for example. It can be located anywhere desired as long as there is adequate space (usually approximately 40 inches minimum).

Installation of the idle elimination apparatus typically involves:

(1) marking and drilling mounting holes.

(2) bolting unit to truck frame with “L” brackets.

(3) hooking into truck fuel line for fuel supply.

(4) routing all electrical and control wiring from idle eliminator along frame rail, up into cab/sleeper to junction/breaker box location.

All other wiring and controls inside of the truck involves mounting the control panel and receptacle(s) in a convenient location and routing all wiring to these and to other on board systems to be powered by the idle elimination apparatus. The heat and air unit has its own digital control thermostat, which is normally mounted near the idle elimination control panel inside of the sleeper area.

Truckers typically run their truck engine at a fast idle (about 1000 to 2000 rpm), so they can operate their heater or air conditioning (AC) unit for comfort. Also the typical trucker has many electrical items in his cab/sleeper, such as: TV, computer, fax, microwave, refrigerator, etc. The idle elimination apparatus is designed to take care of all of these things and more. The idle elimination apparatus provides 115 vac to the truck's cab/sleeper area, allowing any 115 volt electrical apparatus to be plugged into the receptacles provided, up to the output capacity of the generator supplied with the idle elimination apparatus. All of the electrical wire comes through a wire harness from the generator to the junction/breaker box inside of the truck. Preferably, no hard wiring is required for installation of the idle elimination apparatus. All of the cable harnesses are terminated with twist lock connectors—this adds to the simplicity of installing operation and provides a very neat and accurate installation. Components in the junction/breaker box are operated by a control panel, which is mounted inside of the cab/sleeper area. The control panel has switches and a voltage indicator. Items controlled by this system are as follows:

(1) starting and stopping of generator engine,

(2) engine block heater,

(3) 12 volt dc charge circuit for truck batteries,

(4) heater/air conditioner unit, and

(5) auxiliary power.

The engine block heater is an electric heating element that most trucks already have. It is installed into the engine block water jacket. In cold weather, it keeps the engine's water warm which in turn keeps the engine temperature warm enough to allow the engine to start in cold weather. Otherwise, in extreme cold a diesel engine can be impossible to start. The idle elimination apparatus supplies 115 vac to this system via a switch on the control panel. This system is also breakered in the junction/breaker box.

The 12-volt dc charger system is tied to the truck's batteries. The battery charge system preferably is a 60 amp battery charger (standard) with an option of up to an 120 amp battery charger. Truckers normally like to leave their parking lights on at night and/or when sleeping, especially in crowded truck stops. This way, if another truck is parking nearby, the parking lights allow good visibility to others. Also many truckers use inverters to power their electrical apparatus. Inverters change 12 vdc to 115 vac. This uses a considerable amount of current from the truck's batteries. Therefore, when the idle elimination apparatus dc charger system is switched on at the control panel, this allows use of items on the truck that use current from the truck batteries without discharging the truck batteries, and of course without running the truck's engine. This system operates on the 120 volts ac supplied by the idle elimination apparatus and also is breakered in the junction/breaker box. Thus, this system maintains the truck's batteries as needed.

The idle elimination system also provides a heat and air conditioner unit for inside of the truck cab/sleeper. This system is all electric and is totally independent of the truck's existing heat and air unit(s). Again, this is to give comfort inside of the truck allowing the truck engine to be shut down when desired. This system also is breakered in the junction/breaker box.

Also, the idle elimination apparatus is capable of powering and/or controlling other items. For example, it can be used to operate an electric water pump for a fresh water supply (sink, ice maker, shower, etc.). This can be done. In short, the idle elimination apparatus is designed to provide electric power for whatever a trucker may need inside of the truck.

The idle elimination apparatus has the outside appearance of an aluminum diamond plate toolbox, such as is common on trucks. Inside of this box is a single cylinder air-cooled diesel powered generator. The generator is coupled directly onto the power output shaft of the engine. This engine was used to save weight and reduce the size of the box. Since this engine is preferably an air-cooled engine, great detail, design and testing have gone into the enclosure, housing the engine/generator power unit, to allow for adequate cooling. This is done by first removing the hand starting rope assembly. An air chamber is positioned near the engine flywheel at the right end of the box enclosure. Likewise an air chamber is located at the left end of the box enclosure near the end of the generator. When the engine is running, the engine flywheel pulls outside air into the air chamber and this air is forced across the engine cylinder to cool the engine. The cylinder head is shrouded with a strategically designed sheet metal enclosure ensuring all incoming air passes across the engine cylinder head for the most effective cooling. This shrouded enclosure is attached directly to an air chamber that houses a long exhaust header pipe, which leads to the muffler system at the left end of the box enclosure. At the same time, the generator has an impeller (fan blade) inside of it, which pulls outside air into the adjacent air chamber and through the inside of the generator cooling the fields and armature. This air is exhausted upward into the air chamber that houses the exhaust header pipe. Therefore, outside air is pulled into the generator and across the engine and forced out though the main air chamber around the exhaust header pipe. All of the air coming into this air chamber is then forced across the muffler system at the left end of the box enclosure and then exits the box enclosure out into the atmosphere thus cooling the engine/generator. Also critical to cooling is changing out the air inside of the box enclosure. This is the air around the engine/generator. This is done by the use of critically located louver vents, which allow outside air to be drawn into the box enclosure. This air is drawn in by the engine flywheel at the point where the air chamber at the right end of the box enclosure meets the flywheel engine cowling. At this point, there is a slight gap allowing a portion of the box enclosure air to be evacuated along with the outside air being forced across the engine cylinder head. Thus, this allows for adequate control of the air temperature around the engine/generator.

Also, inside of the box enclosure is a control panel. This allows starting and stopping of the idle elimination apparatus from the generator as well as in the truck cab/sleeper as mentioned previously. This control panel has a main power breaker and a tachometer/hour meter for engine monitoring.

The invention system does not cut into a truck's factory air-conditioning system lines or air-conditioning ducting, and does not tie into a truck's engine water lines, or electrical system. Due to this, installation of the invention system is simple enough that the do-it-yourself person is capable of installing the system. Also, this is very attractive to fleets, since most of them will install the system themselves. They can install the system in less time with fewer complications.

### BRIEF DESCRIPTION OF THE DRAWINGS

In the drawings:

FIG. 1 is a side elevated view of a truck with the generator mounted to the frame behind the fuel tank;

FIG. 2 is a perspective view of the generator with the cover on;

FIG. 3 is a side elevational view of the truck with the generator mounted below the doorway, for use as a step;

FIG. 4 is a perspective view of the generator with the step configuration of FIG. 3;

FIG. 5 is a right side elevational view of the generator with the cover on;

FIG. 6 is a left side elevational view of the generator with the cover on;

FIG. 7 is a rear elevational view of the generator with the access panel on;

FIG. 8 is a rear elevational view of the generator with the access panel removed;

FIG. 9 is a front elevational view of the generator with the cover removed;

FIG. 10 is a right side elevational view of the generator with the cover removed;

FIG. 11 is a schematic of the generator control layout;

FIG. 12 is the generator wiring diagram;

FIG. 13 is a top elevational view of the internal layout of the heating/air conditioning unit;

FIG. 14 is a front elevational view of the layout for the digital generator controller;

FIG. 15 is a schematic of the idle eliminator system;

FIG. 16 is a front elevational view of the layout for the heating/air conditioning unit controller;

FIG. 17 is a layout of the inside of the truck with idle elimination system installed;

FIG. 18 is a bottom elevational view of the generator;

FIG. 19 is a diagram of an (on-off) switch that is a 6-pole, double throw (the switch is wired for changing the output voltage of the alternator in FIG. 20 from 30 volts ac to 120 volts ac); and

FIG. 20 is an alternator with 4 windings and each producing 30 volts ac.

### DETAILED DESCRIPTION OF THE INVENTION AND THE DRAWINGS

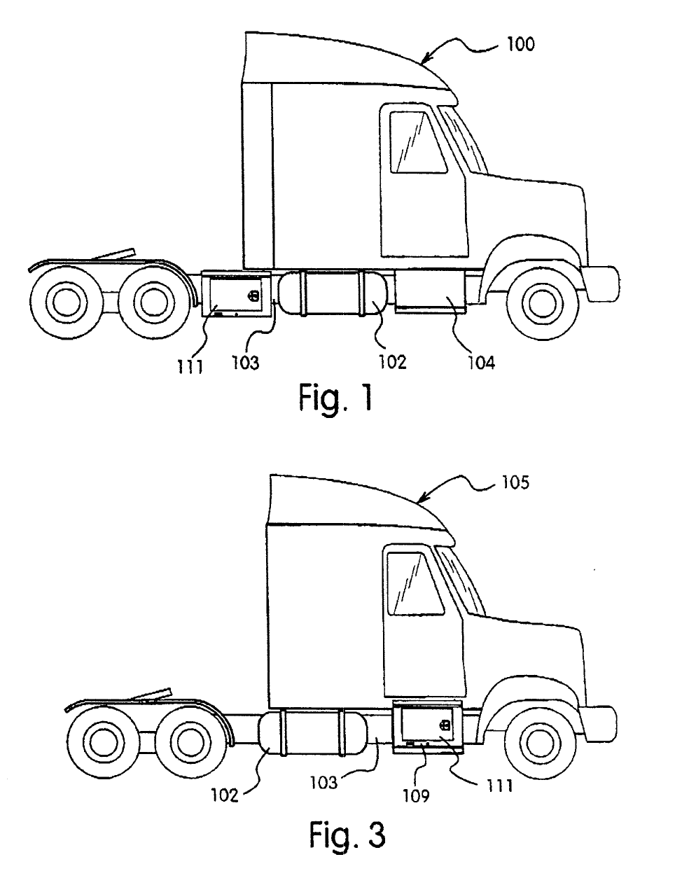

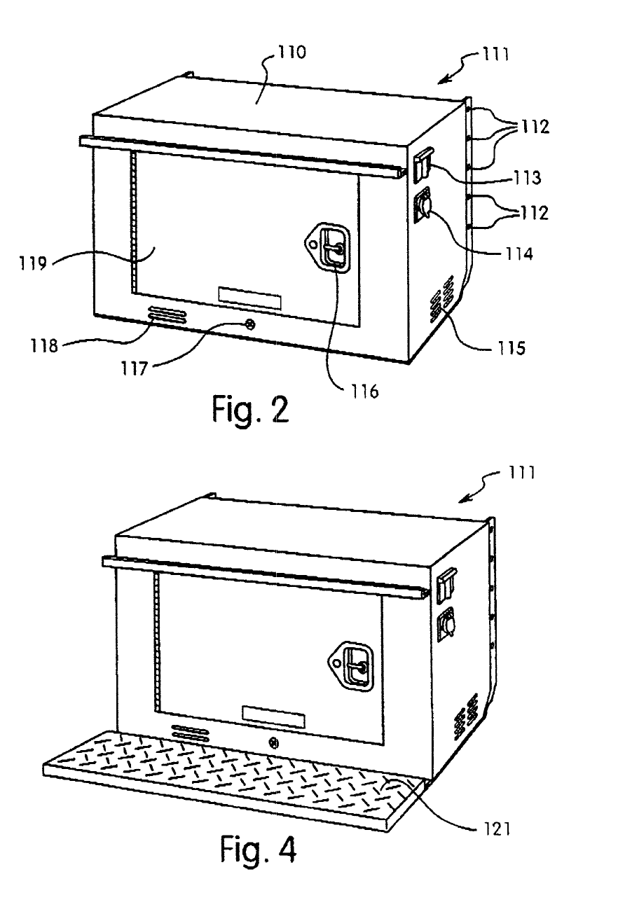

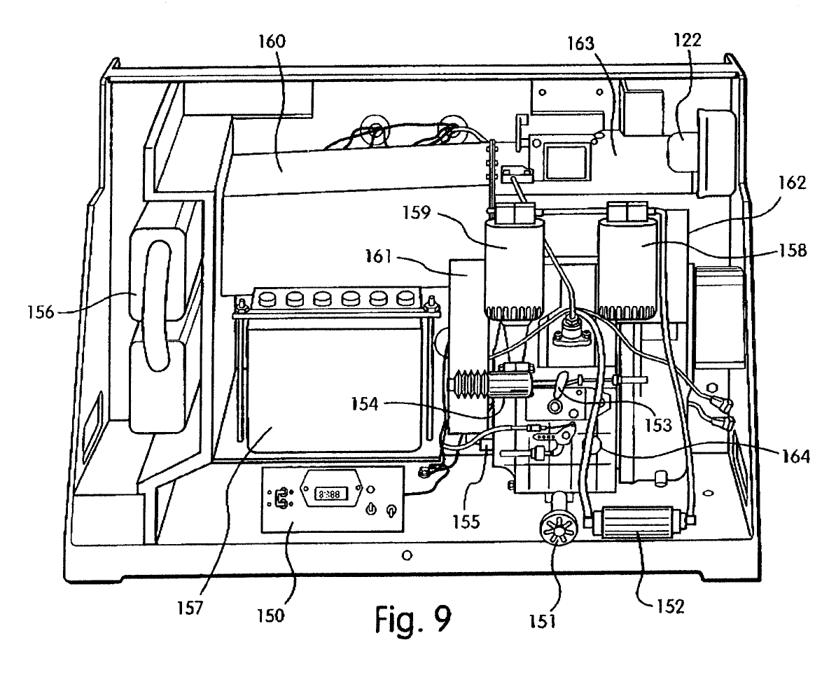

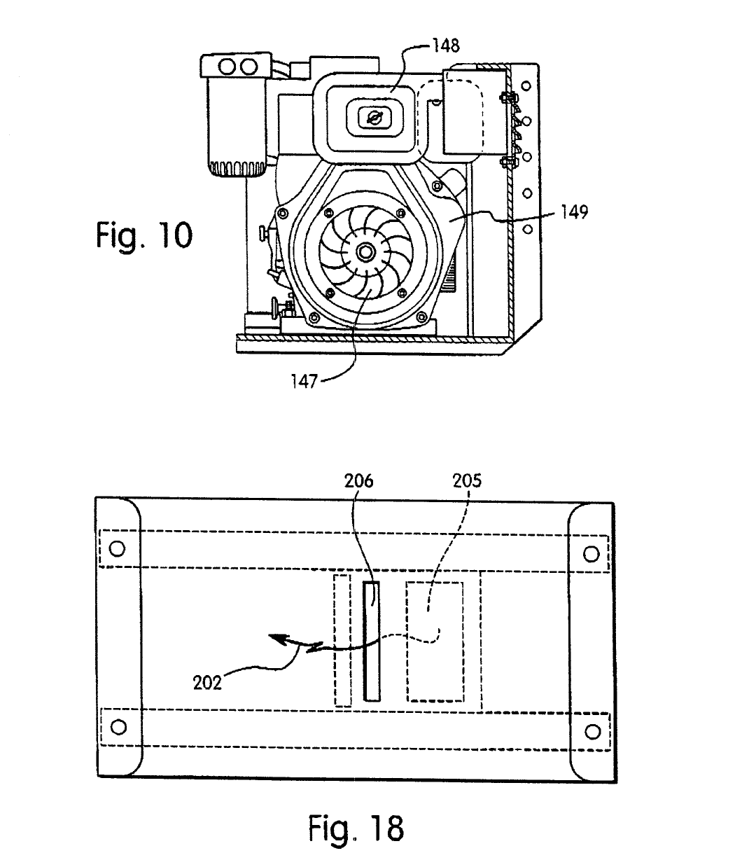

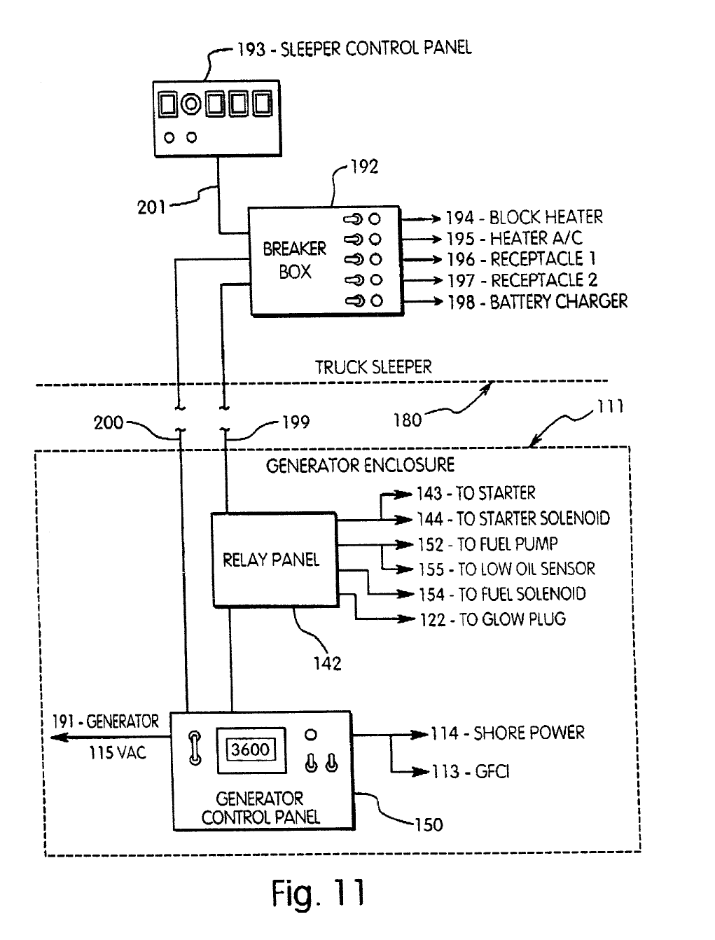

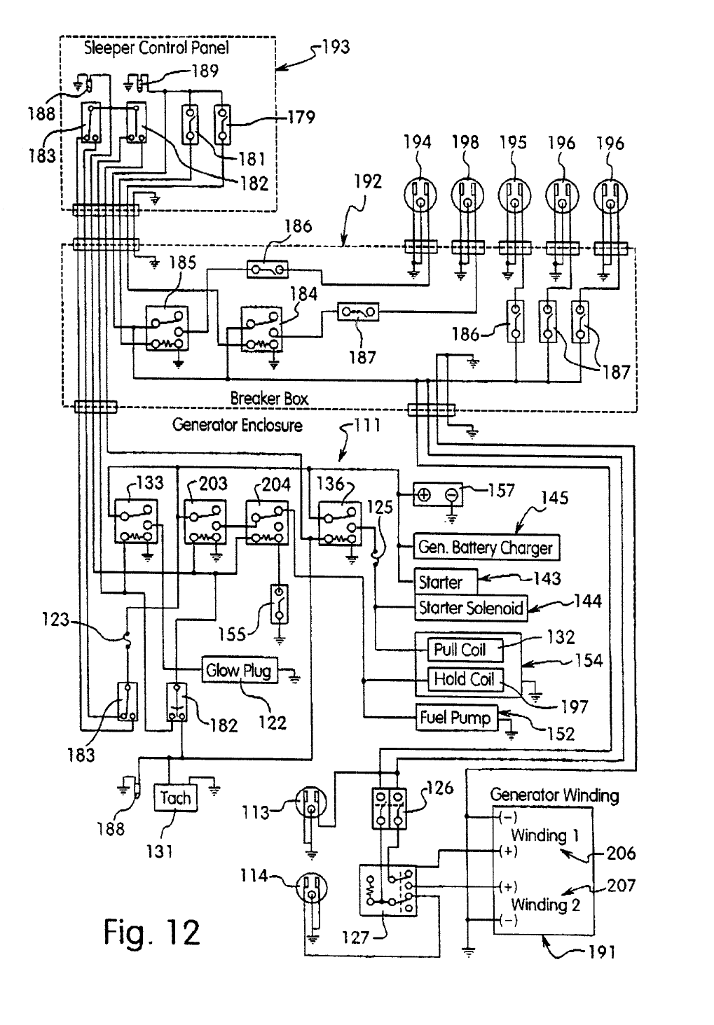

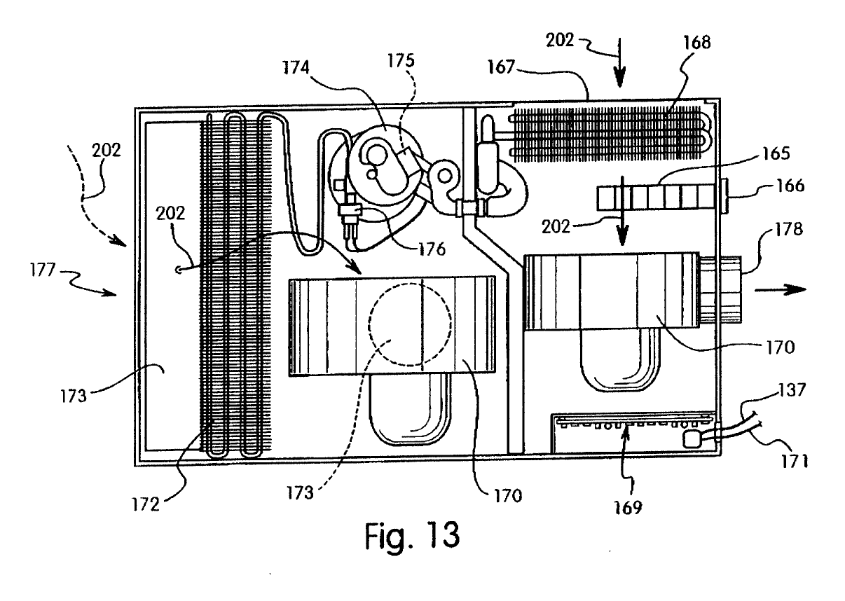

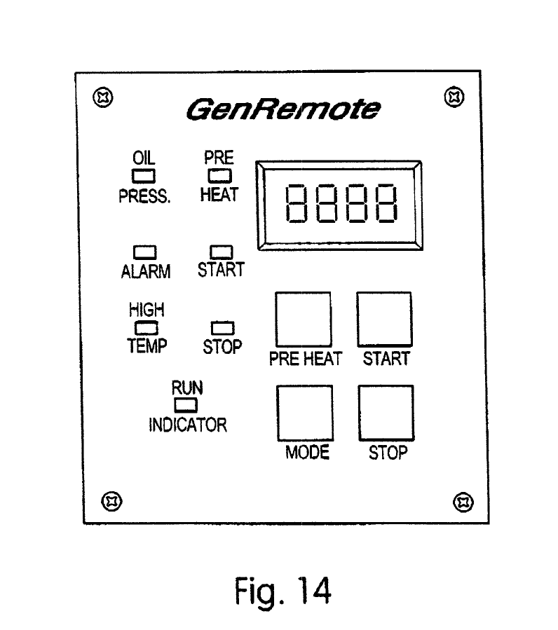

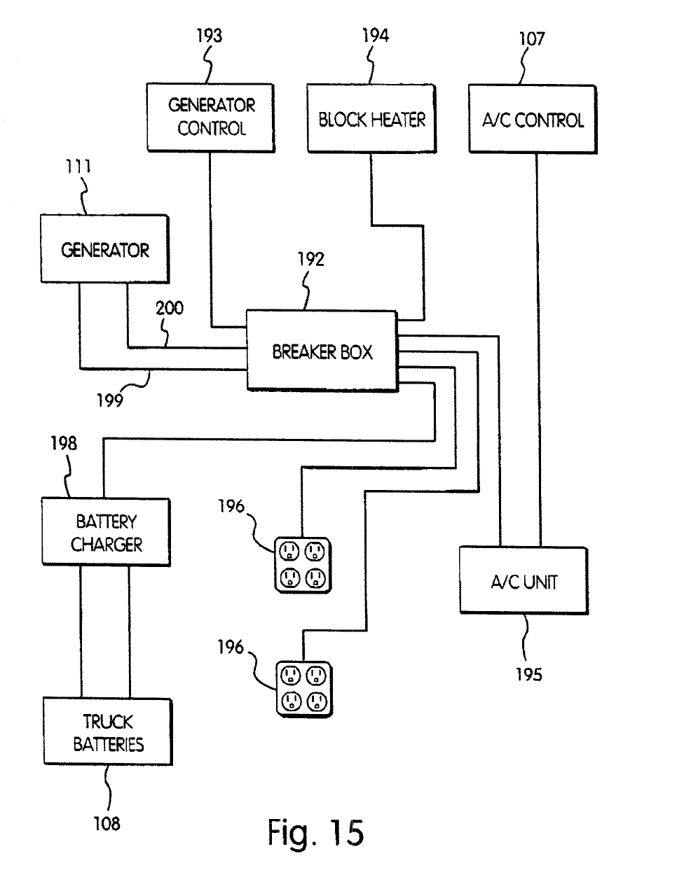

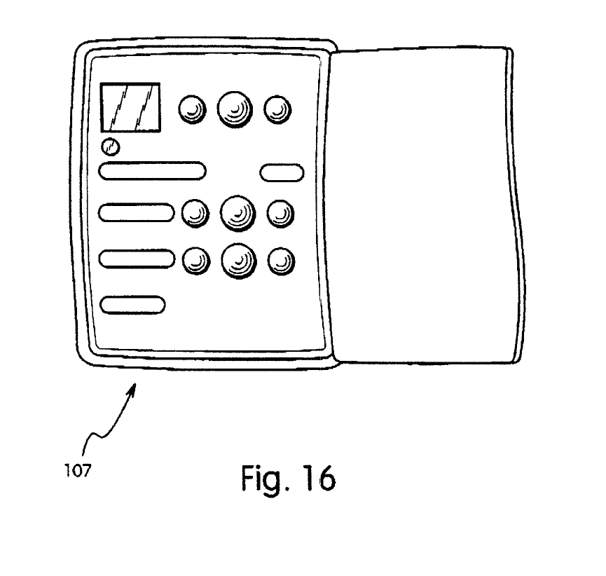

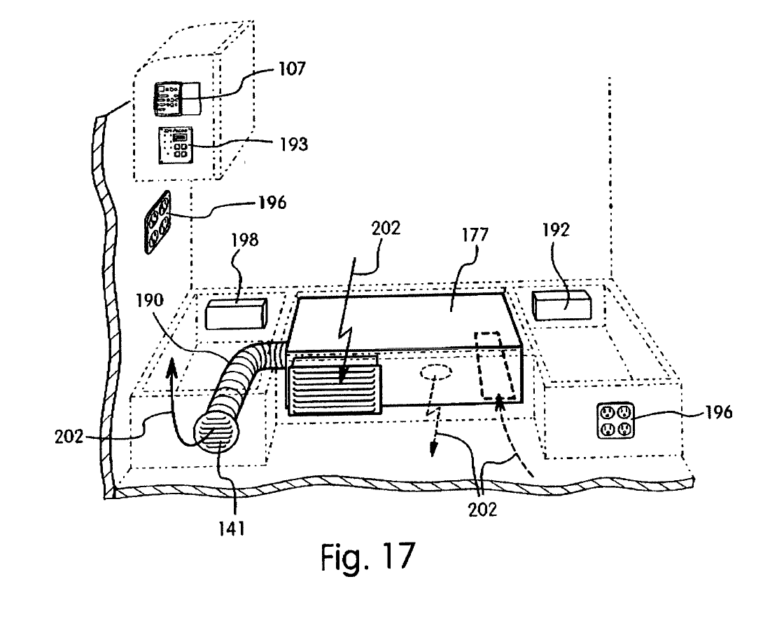

The idle elimination apparatus is designed for the class 7 and 8 trucking industry. The purpose is to eliminate idling of truck engines at night while the driver is sleeping or any other time the truck is not traveling. Apparatus is a stand-alone, APU (Auxiliary Power Unit) generator, powered by a small air-cooled diesel engine 149, which is directly coupled to the alternator 191 to produce a continuous 6000 watts at 120 VAC. The generator powers a 12 volt dc battery charging system which is capable of 60 amps. In conjunction with APU is an ozone friendly HVAC environmental system to heat and cool the cab/sleeper. The complete system, depicted in FIG. 15 integrates with minimal effort, and without invasion into any existing truck systems, such as its refrigerant, water or electrical. Referring to FIG. 1, the generator 101 is mounted to frame 103 behind fuel tank 102. Generator 101 can also be mounted to the frame in the alternate location in FIG. 3. Generator 106 is mounted in front of the fuel tank underneath the passenger doorway with a step configuration. Generators 101 and 106 are the same except generator 106 has step 109 mounted on the lower part of the generator enclosure. This is to replace factory step box 104 shown in FIG. 1. The generator 101/106 cranks over by an internal battery 157 or the battery can be disregarded, and starter 143 can be hooked up directly to the truck's battery bank 108. The generator 101/106 draws diesel fuel from truckfuel tank 102 of the truck. The HVAC (Heating, Venting, Air-Conditioning) system is mounted inside the truck's sleeper as depicted in FIG. 17. Also air flow is shown by lines 202 in FIG. 17. Air exits the unit into ducting 190 and flows out into the sleeper through grill 141. The battery charger 198 is also mounted inside the truck's sleeper along with panels 107 and 193 as FIG. 17 shows. In a broad overview, all 120 VAC flows from generator 101 into breaker box 192 where it is dispersed. Power flows from 192 to each of the following items as shown in FIG. 15: HVAC 177, battery charger 198, receptacles 196, and the power cord going to truck's engine block heater 194. To start the generator, turn on fuel switch 183 at either generator control panel 150 or remote control panel 193. These switches are wired for three-way switching. Fuel indicator 188 will light up. When switch 183 is turned on, 12 volts dc flows from battery 157 through both fuel switches 183 and closes the fuel relay 203. This gives power to the start switches 182 located on both panel 150 and 193. However, 12 volts does not flow to hold coil 197 on fuel solenoid 154 and fuel pump 152 because low oil pressure switch 155 is closed to the ground, which in turn opens a circuit at relay 204, and because the power flowing to components 197 and 152 flows through relay 204. Hence, start switch 182 must be depressed so that the engine can crank over, causing oil pressure and therefore opening low oil pressure switch 155. When oil pressure switch 155 receives oil pressure and opens, this allows power to flow through relay 204 to fuel pump 152 and hold coil 197. However, because fuel solenoid 154 has two coils, a hold coil 197 and a pull coil 132, it can not push throttle lever 153 to “on” until pull coil 132 receives voltage. This is accomplished when start switch 182 is depressed also. When switch 182 is depressed, 12 volts flows from battery 157 through switches 183 and 182 and closes relay 136. When relay 136 closes, 12 volts are given to pull coil 132 and to start solenoid 143. The start switch is depressed until the engine starts. If engine oil pressure is too low, then low oil pressure switch 155 will close, in turn shutting off the engine, by opening relay 204 which turns the power off to hold coil 132 and fuel pump 152. When hold coil 132 receives no power, fuel lever 153 returns to the off position. Also for protection of the circuit, if start switch 182 is depressed too long or if failure occurs within relay 136 or start switch 182, manual reset circuit breaker 125 trips, shutting the power off to the complete start circuit. Also, if a short in the 12 volt circuitry occurs, fuse 123 will blow and prevent power from flowing to control panel 193 and components 143, 144, 154 and 152. When engine 149 is running, it charges generator battery 157. Engine 149 has a winding behind flywheel 147, which produces a small AC current that flows through a converter with built in voltage regulator 145. The voltage regulator is connected to generator battery 157, as shown in FIG. 12. Also, when engine 149 is running, it turns alternator 191 which is directly mounted to the engine's crank shaft. The alternator internally consists of two windings, winding I 206 and winding II 207, which each typically produces 120 vac. The two windings are wired in parallel, which means the positive wires of each winding are connected and the negative wires of each winding are connected. When windings are connected in parallel, the total output is 120 vac and the maximum output amps is doubled. The negative wires of each winding are connected to the truck's frame 103 for grounding. However, the two windings 206 and 207 can be wired in series, which means the positive wire of winding II 207 is connected to the negative wire of winding I 206. This cinerea produces 240 vac, to be measured between the positive wire of winding I 206 and the negative wire of winding II 207. Power from alternator 191 flows through main power relay 127. This relay switches from alternator power to shore power receptacle 114. When relay 127 receives 120 vac, it closes and connects the alternator power to the circuit. Shore power receptacle 114 allows for an alternate power supply to be plugged into the circuit. The generator is bypassed and 120 vac is made available into the truck as if a generator were running. 120 vac then flows through main breaker 126 and then through cable 200 to breaker box 192, which is mounted inside of the truck. Also, power flows from main breaker 126 to receptacle plug 113, which is mounted outside on generator 101 enclosure above shore power receptacle 114, as shown in FIG. 2. The power is distributed at breaker box 192 and 120 vac flows through breakers 187 to receptacle I 196, which is mounted inside the truck. 120 vac also flows to receptacle II 196 in the same manner, only through another breaker 187. The power flows through breaker 186 out of breaker box 192 to HVAC system 177. Also, the power flows through relay 184 and through breaker 187 to battery charger 198. However, for the battery charger to come on, battery charger switch 179 must be in the on position. When switch 179 is on, 120 vac is given to relay 184, which in turn closes relay 184 so that the power can flow to battery charger 198. Also, the power flows through relay 185 and through breaker 186 to block heater 194. However, in order for the block heater to receive power, block heater switch 181 on remote panel 193 must be turned on. When switch 181 is in the on position, 120 vac is given to relay 185 and relay 185 closes, so that the power can flow through it to block heater 194. Also, 120 vac flows through remote control cable 201 to remote control panel 193, and power indicator 189 lights up. 120 vac is also made available to the block heater switch 181 and the battery charger switch 179, which are located on panel 193. For starting the generator in extreme cold weather, the glow plug 122 should be switched on to preheat the intake air for the engine. Depress switch 182 on either panel 150 or panel 193. This gives 12 volts dc to relay 133, which now closes and gives 12 volts dc to glow plug 122. For the location of glow plug 122 with respect to engine 149, see FIG. 9. Glow plug switch 182 should be depressed 15 to 20 seconds prior to starting the engine. Generator 101/106 can be started and turned off from either remote panel 193 or control panel 150. Block heater 194 and battery charger 198 must be turned on at remote control panel 193. HVAC system 177 must be turned on and off from its digital controller 107. HVAC controller 107 in mounted inside the truck, and has the following settings: the blower speed manual or automatic, the thermostat up or down temperature settings between 55 degrees F. and 95 degrees F., and a heat or cooling mode or dual mode which will heat or cool depending on the thermostat setting. In FIG. 13 and FIG. 17, 202 depicts air flow lines for HVAC 177. When the cooling is on, return air 167 is drawn through condenser 168, which cools air, and blower 170 distributes climate controlled air through opening 178. Fresh air is drawn from outside of the truck through opening 173 to cool evaporator coil 172. Hot air is removed from the sleeper compartment and then expelled outside through opening 173 by blower 170. In the heating mode, return air is drawn through opening 167 and across heating element 165 by blower 170 and emitted out into the sleeper compartment through opening 178. For the protection of the A/C compressor 174, there is a high pressure shut off valve 176 and a thermal overload 175. Also for protection of the heating element 165 there is manual reset button 166.

The battery charger 198 plugs into breaker box 192 for 120 VAC. The battery charger 198 converts 120 VAC to 12 volts dc. The 12 volt dc charging circuit has two cables, one positive and one negative, that connect to the trucks battery bank 108 as shown in FIG. 15. The battery charger 198 can be on for long periods of time without overcharging or harming the trucks batteries 108. The electronics in the battery charger 198 monitor the batteries 108 at all times and only supplies power to the batteries when they call for it.

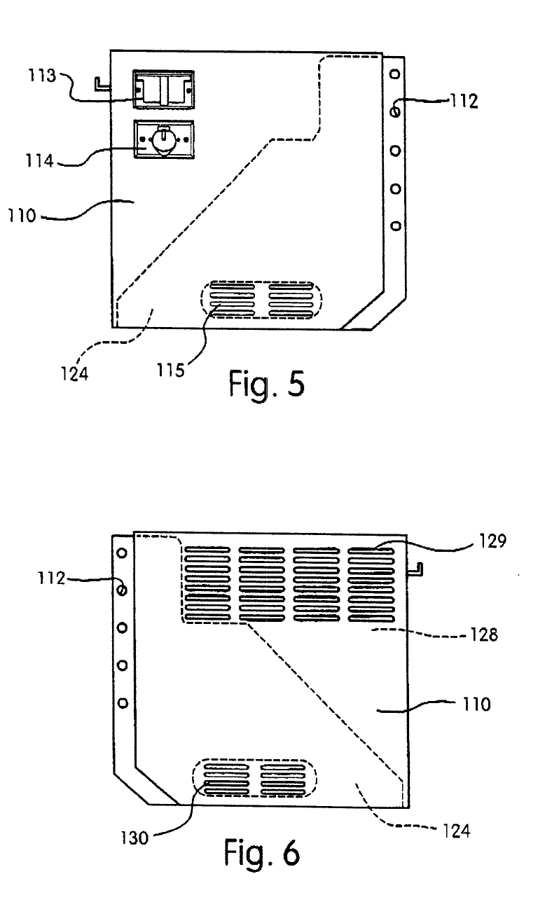

Since the engine 149 is air-cooled, venting for it is very critical. The flywheel 147 is utilized not only for cooling the engine, but also for pulling some fresh air through enclosure. The flywheel pulls the majority of fresh air through slots 115 of cover 110. However, flywheel also pulls from vents 118 and through gap 162. Then, the flywheel pushes air through ducting 163 around the head of engine and into ducting 160. The air is then pushed across muffler 156 and out of the enclosure through vent 129. Also, flywheel 147 pushes some air across engine pump 205 and out of the bottom of the enclosure through slot 209 as in FIG. 18. The alternator 191 also has turbine 208 in it, which is located behind air ducts 161. It draws air from slots 130 shown in FIG. 5 and expels air through air ducts 161 into air ducting 160 where it is then pushed across muffler 156 and out of slots 129.

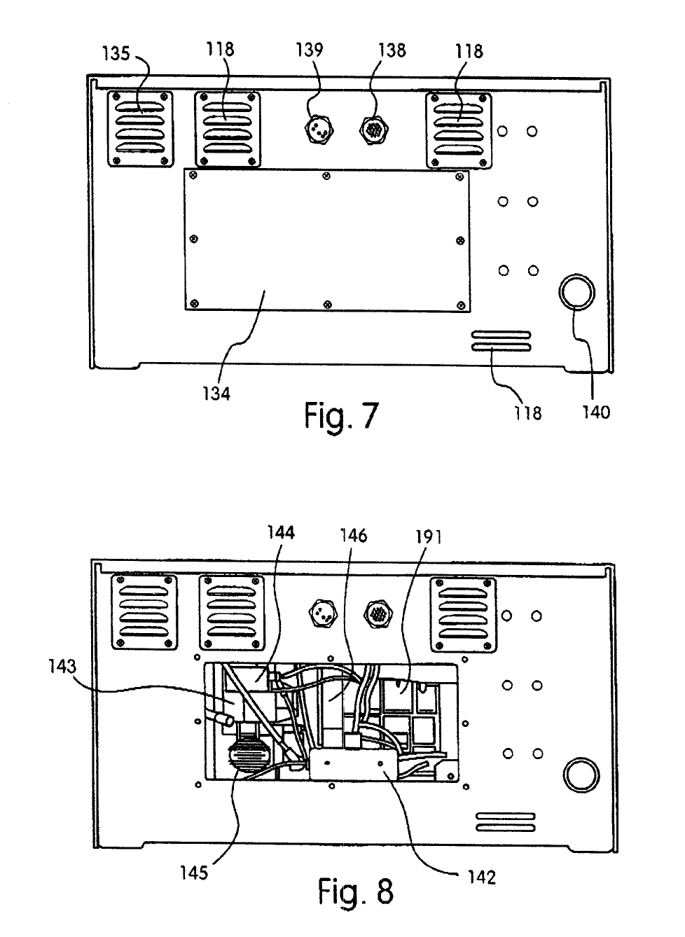

For combustion, the engine draws intake air through vent 135 shown in FIG. 7 and then through the air cleaner 148 into the engine for combustion. The engine exhaust flows through muffler 156 and exits out the rear of the enclosure at 140 shown in FIG. 7.

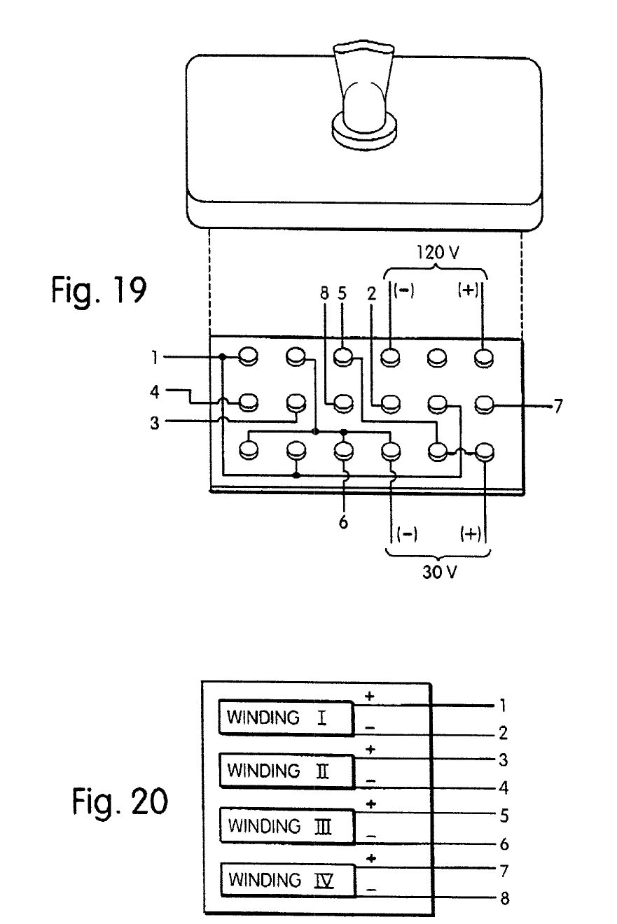

In certain applications, 30 volts ac is required to run a certain apparatus on a truck. The alternator in FIG. 20 is made up of four windings. Each winding produces 30 volts ac. When windings are wired in parallel, 30 volts ac is acquired, and when the four windings are wired in series, 120 volts ac is acquired. Parallel means the positive wires (1, 3, 5 and 7) of each winding in FIG. 20, are connected together and the negative wires (2, 4, 6 and 8) of each winding are connected together. Series means the negative wire 2 of winding “I” is connected to the positive wire 3 of winding “II” and the negative wire 4 of winding “II” is connected to the positive wire 5 of winding “II” and the negative wire 6 of winding “III” is connected to the positive wire 7 of winding “IV”. The switch shown in FIG. 19 is used to switch the windings from parallel to series. This enables 30 volts ac or 120 volts to be available at the flip of the switch, as depicted in FIG. 19.

Preferably, a digital control panel is used rather than the analog control panel described above. Slight modifications of the wiring will be required, as follows:

(1) The mechanical relays inside of the generator box/enclosure and inside of the junction/breaker box will both be replaced with electronic printed circuit boards.

(2) The control panel inside of the cab/sleeper area will be replaced with a digital touch pad, incorporating mode and function controls. This will consist of a digital display showing the state of each function, for example, fuel on, battery charge on, etc. The display will also provide monitoring of the battery voltage and/or current output.

The following is a list of the reference numerals used in the specification and drawings:

100 Truck with the idle elimination system

101 Generator mounted to frame behind fuel tank

102 Fuel tank

103 Truck frame rail

104 Tool box with step for entrance into truck

105 Truck with the idle elimintation system; step configuration

106 Generator mounted to frame under doorway

107 HVAC remote controller

108 Truck battery bank

109 Step mounted on generator for entrance into truck

110 Generator cover

111 Generator (APU/Auxiliary Power Unit)

112 Mounting holes for mounting to frame rail of truck

113 Duplex GFCI 15A receptacle for 120 volts ac

114 Shore power receptacle; plug into other power supply to bypass generator

115 Air vent slots for cooling engine; engine flywheel draws air through slots

116 Door latch

117 Bolt for holding cover on

118 Air vent slots for fresh air into enclosure

119 Generator door

120 Generator with step configuration

121 Step kit

122 Air heater/glow plug

123 10 amp in line fuse

124 Base of generator enclosure; main support

125 15 amp manual reset fuse

126 30 amp on-off, double pole, double throw breaker switch

127 120 volts ac relay—30 amp double pole, double throw

128 Dual stage muffler located behind cover

129 Air vent slots in cover for hot air to be blown out across muffler

130 Air vent slots for alternator to pull fresh air through for cooling

131 Tachometer and hour meter

132 Pull coil for fuel solenoid

133 12 volts dc relay—40 amp single pole, double throw

134 Rear access panel

135 Air vent slots for engine air breather

136 12 volt dc relay—70 amp single pole, double throw

137 HVAC power cord

138 Main power cable hookup

139 Generator control cable hookup

140 Exhaust pipe from muffler

141 Air vent grill for climate controlled airflow

142 Relay panel

143 Starter

144 Starter solenoid

145 Automatic voltage regulator to charge generator battery

146 Air duct for hot air leaving alternator

147 Engine flywheel

148 Engine air cleaner/breather cover

149 Engine

150 Generator control panel

151 Oil drain valve

152 Fuel pump

153 Fuel throttle lever

154 Fuel solenoid

155 Low oil sensor

156 Dual stage muffler

157 Battery for generator

158 Spin-on oil filter

159 Spin-on fuel filter

160 Air duct for hot air leaving from engine, alternator and enclosure

161 Air duct for hot air leaving alternator

162 Gap between engine and enclosure so that engine flywheel can pull some hot air out of enclosure

163 Air duct shroud around engine head

164 Oil dipstick and oil fill hole into crank case

165 2000 watt heating element

166 Manual reset for heating element

167 Return air opening

168 Condenser

169 HVAC control circuit board

170 Blower

171 Control cable for HVAC

172 Evaporator

173 Fresh air hole

174 Compressor

175 Thermal overload

176 High pressure switch

177 HVAC unit (heating, venting, air-conditioning)

178 Climate controlled air vent

179 Battery charger switch (on-off)

180 Inside of truck's sleeper

181 Block heater switch (on-off)

182 Start switch for generator and air heater switch for generator [momentary (on)—of—momentary (on)]

183 Fuel on switch (on—none—on)

184 120 volt ac relay—15 amp single pole, single throw

185 120 volt ac relay—25 amp single pole, single throw

186 25 amp on-off breaker switch

187 15 amp on-off breaker switch

188 Indicator light for fuel on

189 Indicator light for 120 volts ac

190 5½″ convoluted ducting

191 120 volt ac alternator

192 Breaker box

193 Remote control panel for generator

194 Block heater for truck's engine

195 Two duplex receptacles for 120 volts ac encased by surface mount, injection molded panel

196 Hold coil for fuel solenoid

197 Battery charger for the truck's batteries

198 Generator main control cable

199 Generator main power cable

200 Remote control panel control cable for generator

201 Air flow lines

202 Fuel relay, 12 volt dc relay—40 amp single pole, double throw

203 Low oil pressure relay, 12 volt dc relay—40 amp single pole, double throw

204 Engine oil pump

205 Alternator winding I (120 volts ac)

206 Alternator winding II (120 volts ac)

207 Alternator turbine/fan

208 Vent slot on bottom of generator enclosure

What is claimed is:

1. Apparatus for elimination of the need for idiling of engine of a truck when the truck is not moving under motorized power, comprising:
(a) means for heating and cooling cab of the truck;
(b) means for charging at least one battery in said truck; and
(c) generator means for supplying electricity to means (a) and means (b)

2. The apparatus of claim 1, wherein the generator means (c) is a generator.

3. The apparatus of claim 2, wherein the generator also supplies electricity to electrical systems of the truck other than means (a) and means (b).

4. The apparatus of claim 1, wherein the means (a) is a unit capable of heating and cooling atmosphere in the cab of the truck.

5. The apparatus of claim 1, wherein the means (b) is a battery charger.

6. The apparatus of claim 5, wherein the generator means (c) is a generator and a battery, the battery being capable of starting the generator, the battery charger being capable of charging the battery of generator means (c).

7. The apparatus of claim 1, wherein the generator means (c) is a generator, the means (a) is a unit capable of heating and cooling atmosphere in the cab of a truck and the means (b) is a battery charger.

8. The apparatus of claim 7, wherein the apparatus also includes an immersion block heater that is installed in water jacket in engine block of engine of the truck.

9. The apparatus of claim 1, wherein means (a) is contained in a single enclosure that is mounted on the frame of the truck.

10. The apparatus of claim 9, wherein the enclosure is located under a door of the cab of the truck and has a step appendage.

11. Combination of a truck and a apparatus, the apparatus being mounted on the truck, the apparatus eliminates the need for idiling of engine of the truck not moving under motorized power, the apparatus comprises:
(a) means for heating and cooling cab of the truck;
(b) means for charging at least one battery in said truck; and
(c) generator means for supplying electricity to means (a) and (b).

12. The combination of claim 11, wherein the generator means (c) is a generator.

13. The combination of claim 12, wherein the generator also supplies electricity to electrical systems of the truck other than means (a) and means (b).

14. The combination of claim 11, wherein the means (a) is a unit capable of heating and cooling atmosphere in the cab of the truck.

15. The combination of claim 11, wherein the means (b) is a battery charger.

16. The combination of claim 15, wherein the generator means (c) is a generator and a battery, the battery being capable of starting the generator, the battery charger being capable of charging the battery of generator means (c).

17. The apparatus of claim 11, wherein the generator means (c) is a generator, the means (a) is a unit capable of heating and cooling atmosphere in the cab of a truck, and the means (b) is a battery charger.

18. The apparatus of claim 17, wherein the apparatus also includes an immersion block heater that is installed in water jacket in engine block of engine of the truck.

19. The apparatus of claim 17, wherein means (a) is contained in a single enclosure that is mounted on the frame of the truck.

20. The apparatus of claim 19, wherein the enclosure is located under a door of the cab of the truck and has a step appendage.
